(19) United States
(12) Patent Application Publication
(10) Pub. No.: US 2008/0136062 A1
(43) Pub. Date: Jun. 12, 2008

(54) DRYING APPARATUS, METHOD FOR DRYING CERAMIC MOLDED BODY, AND METHOD FOR MANUFACTURING HONEYCOMB STRUCTURE

(75) Inventors: Kenichiro KASAI, Ibi-gun (JP); Kazuya Naruse, Courtenay (FR)

Correspondence Address: DITTHAVONG MORI & STEINER, P.C., 918 Prince St., Alexandria, VA, 22314, US

(73) Assignee: IBIDEN CO., LTD., Ogaki (JP)

(21) Appl. No.: 11/958,247

(22) Filed: Dec. 17, 2007

Related U.S. Application Data
(63) Continuation of application No. PCT/JP2006/305438, filed on Mar. 17, 2006.

(51) Int. Cl. B29C 35/04

(52) U.S. Cl. 264/426; 425/174.4; 264/177.12; 34/265

(57) ABSTRACT

A drying apparatus including a conveying member configured to convey an item to be dried, a plurality of microwave irradiation portions disposed alternately at an upper side and a lower side of the conveying member, and a plurality of hot air blowing portions. The microwave irradiation portions are configured to irradiate the item to be dried with microwaves in an alternating manner from the upper side and the lower side. The hot air blowing portions are configured to apply hot air to the item to be dried in parallel with irradiation of the microwaves by the microwave irradiation portions.

### CROSS-REFERENCE TO RELATED APPLICATIONS

The present application claims priority to PCT Application No. PCT/JP2006/305438, filed on Mar. 17, 2006, the contents of which are incorporated herein by reference in their entirety.

### BACKGROUND OF THE INVENTION

1. Field of the Invention

The present invention relates to the manufacture of ceramic molded bodies that can be used, for example, to filter exhaust gases of internal combustion engines or as a catalyst supporting carrier.

2. Discussion of the Background

Harm to the environment and the human body caused by particulates such as soot contained in exhaust gases discharged from the internal combustion engines of buses, trucks and other vehicles, construction equipment and the like has recently become a problem. To remedy this, there are currently proposed numerous kinds of filters using a honeycomb structure including porous ceramic as a filter for capturing particulates contained in exhaust gases, thereby purifying the exhaust gases.

Conventionally, when manufacturing a honeycomb structure, for instance, first two kinds of ceramic powders having different average particle diameters, a binder, and a liquid dispersant are combined to prepare a wet mixture. This wet mixture is further mixed by using a screw mixing machine, then continuous extrusion molding is carried out using a die, and then the extruded molded body is cut to a prescribed length so that a rectangular pillar shaped honeycomb molded body is produced.

Next, the raw honeycomb molded body attained above is dried using microwave drying or hot-air drying, thereby manufacturing a dried body of a honeycomb molded body having a consistent degree of strength and which can be handled easily.

After the drying, prescribed cells are sealed to thereby achieve a plugged state of either end portion of the cells by a plug material layer. After the plugged state has been achieved, degreasing is carried out on the honeycomb molded body at a temperature in the range of 400 to 650° C. and under oxygen containing atmosphere to volatilize the solvent within the organic binder component while breaking down and eliminating resin components therein. Furthermore, firing is carried out on the honeycomb molded at a temperature in the range of 2000 to 2200° C. and under inert gas atmosphere thereby manufacturing the honeycomb fired body.

After this, a sealing material paste is applied to the side faces of the honeycomb fired bodies to adhere the honeycomb fired bodies together so that an aggregate of honeycomb fired bodies having a multitude of honeycomb fired bodies bonded together by interposing a sealing material layer (an adhesive layer) is manufactured. Then, a cutting machine is used to form a ceramic block of a prescribed form, such as a round pillar or cylindroid form and the like. Finally, sealing material paste is applied to the periphery of the ceramic block to form a sealing material layer (a coat layer), thus completing the manufacture of the honeycomb structure.

Also, when drying the honeycomb molded body in the method for manufacturing this kind of honeycomb structure, there is known a drying method of a honeycomb molded body according to irradiating microwaves from a single direction (for example, see JP-A 2001-130970 and JP-A 2005-131800). The contents of JP-A 2001-130970 and JP-A 2005-131800 are incorporated herein by reference in their entirety.

### SUMMARY OF THE INVENTION

The present invention advantageously provides a drying apparatus including a conveying member configured to convey an item to be dried, a plurality of microwave irradiation portions disposed alternately at an upper side and a lower side of the conveying member, and a plurality of hot air blowing portions, where said microwave irradiation portions are configured t irradiate the item to be dried with microwaves in an alternating manner from the upper side and the lower side, and the hot air blowing portions are configured to apply hot air to the item to be applied in parallel with irradiation of the microwaves by the microwave irradiation portions.

In an embodiment of the drying apparatus of the present invention, a microwave agitation blade is preferably provided at a ceiling portion of the drying apparatus, and the microwave agitation blade is preferably installed near each of the microwave irradiation portions.

In an embodiment of the drying apparatus of the present invention, the conveying member is preferably a belt conveyor onto which a ceramic molded body is to be placed, and the belt conveyor moves intermittently, or continuously at a constant or varying speed.

It is preferable that an embodiment of the drying apparatus of the present invention further includes a plurality of hot air aspiration portions, and the hot air blowing portions and the hot air aspiration portions are disposed in an opposing manner on opposing side of the conveying member.

In an embodiment of the drying apparatus of the present invention, the conveying member is preferably configured to convey a honeycomb molded body as the item to be dried.

The present invention further advantageously provides a method for drying a ceramic molded body including placing a ceramic molded body on a conveying member, and passing the ceramic molded body through an interior of a drying apparatus to dry the ceramic molded body, wherein the ceramic molded body is passed through the interior of the drying apparatus in a prescribed period of time by using the conveying member, where the drying apparatus includes a plurality of microwave irradiation portions disposed alternately at an upper side and a lower side of the conveying member and a plurality of hot air blowing portions, and where as the ceramic molded body is passed through the interior of the drying apparatus, the microwave irradiation portions irradiate the ceramic molded body with microwaves in an alternating manner from the upper side and the lower side and the hot air blowing portions carry out a hot air drying in parallel with irradiation of the microwaves.

In an embodiment of the method for drying a ceramic molded body of the present invention, a moisture content of the ceramic molded body after drying is preferably about 30% by weight or more and is less than about 70% by weight of the moisture content before drying, and a temperature of hot air from the hot air blowing portions is preferably at least about 40° C. and at most about 80° C. Also, the belt conveying member is preferably a belt conveyor.

In an embodiment of the method for drying a ceramic molded body of the present invention, it is preferable that the prescribed period of time is at least about 2 minutes and at most about 3 minutes, airspeed of hot air from the hot air blowing portions is at least about 20 m/sec and at most about 40 m/sec, and the ceramic molded body is a honeycomb molded body.

The present invention further advantageously provides a method for manufacturing a honeycomb structure including: producing a pillar-shaped honeycomb molded body having a multiplicity of cells placed in parallel with one another in a longitudinal direction with a cell wall therebetween by molding a ceramic raw material; placing the honeycomb molded body on a conveying member; drying the honeycomb molded body by passing the honeycomb molded body through an interior of the drying apparatus, where the honeycomb molded body is passed through the interior of the drying apparatus in a prescribed period of time using the conveying member; and firing the dried honeycomb molded body to manufacture a honeycomb structure having a honeycomb fired body, where the drying apparatus includes a plurality of microwave irradiation portions disposed alternately at an upper side and a lower side of the conveying member and a plurality of hot air blowing portions, and where as the honeycomb molded body is passed through the interior of the drying apparatus, the microwave irradiation portions irradiate irradiates the honeycomb molded body with microwaves in an alternating manner from the upper side and the lower side and the hot air blowing portions carry out a hot air drying in parallel with irradiation of the microwaves.

In an embodiment of the method for manufacturing a honeycomb structure of the present invention, it is preferable that a moisture content of the honeycomb molded body after drying is about 30% by weight or more and is less than about 70% by weight of the moisture content before drying, and a temperature of hot air from the hot air blowing portions is at least about 40° C. and at most about 80° C. Also, the conveying member is preferably a belt conveyor.

In an embodiment of the method for manufacturing a honeycomb structure of the present invention, it is preferable that the prescribed period of time is at least about 2 minutes and at most about 3 minutes, airspeed of hot air from the hot air blowing portions is at least about 20 m/sec and at most about 40 m/sec. It is also preferable that further drying is carried out on the honeycomb molded body in a state in which the honeycomb molded body is held by a drying jig, in order to nearly completely eliminate the moisture within the honeycomb molded body. The further drying is preferably carried out using hot air.

In an embodiment of the method for manufacturing a honeycomb structure of the present invention, it is preferable that degreasing and firing are carried out on the honeycomb molded body in a state in which a multitude of cells are placed in parallel with one another in the longitudinal direction with a cell wall therebetween, and a plug material paste being filled in a prescribed cell.

In an embodiment of the method for manufacturing a honeycomb structure of the present invention, it is preferable that the honeycomb structure is comprised of a plurality of honeycomb fired bodies bound together by interposing a sealing material, and the honeycomb structure is comprised of one honeycomb fired body.

### BRIEF DESCRIPTION OF THE DRAWINGS

A more complete appreciation of the invention and many of the attendant advantages thereof will become readily apparent with reference to the following detailed description, particularly when considered in conjunction with the accompanying drawings, in which:

FIG. 1 is a plan view showing a general representation of an embodiment of a drying apparatus according to the present invention;

FIG. 2A is a partial cross-sectional view of the drying apparatus taken along line A-A in FIG. 1, and FIG. 2B is a partial cross-sectional view of the drying apparatus taken along line B-B in FIG. 1;

FIG. 3 is a perspective view depicting an embodiment of a drying jig;

FIG. 4 is a perspective view depicting an embodiment a honeycomb structure;

FIG. 5A is a perspective view schematically showing a honeycomb fired body forming the honeycomb structure, and FIG. 5B is a cross-sectional view of the honeycomb fired body taken along a plane extending longitudinally from line A-A in FIG. 5A; and

FIGS. 6A and 6B are schematic views describing a method of evaluating handleability.

### DETAILED DESCRIPTION OF EMBODIMENTS OF THE INVENTION

Embodiments of the present invention will be described hereinafter with reference to the accompanying drawings. In the following description, the constituent elements having substantially the same function and arrangement are denoted by the same reference numerals, and repetitive descriptions will be made only when necessary.

A drying apparatus according to an embodiment of the present invention includes a conveying member configured to convey an item to be dried, a plurality of microwave irradiation portions disposed alternately at an upper side and a lower side with respect to a conveying member for conveying an item to be dried, and a plurality of hot air blowing portions, where the item to be dried is irradiated with microwaves in an alternating manner from the upper side and the lower side, and hot air is applied in parallel with irradiation of the microwaves, to the item to be dried.

According to the drying apparatus relating to the embodiments of the present invention, because it becomes easier to irradiate microwaves to the item to be dried in an alternating manner from the upper side and the lower side while applying hot air in parallel with the microwave irradiation, to the item to be dried, it becomes easier to achieve uniform drying of the items to be dried such as ceramic molded bodies. Therefore, in items to be dried which are dried using the drying apparatus according to the embodiments of the present invention, warpage or the like becomes less likely to occur.

A method for drying a ceramic molded body according to an embodiment of the present invention includes passing a ceramic molded body through an interior of a drying apparatus to dry the ceramic molded body, which is carried out in a prescribed period of time by using a conveying member, where the drying apparatus includes a plurality of microwave irradiation portions disposed alternately at the upper side and the lower side with respect to the conveying member and a plurality of hot air blowing portions, and where the drying apparatus irradiates the ceramic molded body with microwaves in an alternating manner from the upper side and the lower side and carries out a hot air drying in parallel with irradiation of the microwaves.

According to the drying method of a ceramic molded body relating to the embodiments of the present invention, because it is possible to irradiate microwaves to the ceramic molded body in an alternating manner from the upper side and the lower side while applying hot air in parallel with the microwave irradiation, to the ceramic molded body, it becomes easier to achieve uniform drying of the ceramic molded body, and because of this, warpage or the like becomes less likely to occur in the ceramic molded body after drying.

A method for manufacturing a honeycomb structure according to an embodiment of the present invention includes: manufacturing a pillar-shaped honeycomb molded body having a multiplicity of cells placed in parallel with one another in a longitudinal direction with a cell wall therebetween by molding a ceramic raw material; carrying out drying of a molded body including passing the honeycomb molded body through the interior of a drying apparatus to dry the honeycomb molded body, which is carried out in a prescribed period of time with the honeycomb molded body placed onto a conveying member; and firing the dried honeycomb molded body to manufacture a honeycomb structure having a honeycomb fired body, where the drying apparatus includes a plurality of microwave irradiation portions disposed alternately at the upper side and the lower side with respect to the conveying member and a plurality of hot air blowing portions, and where the drying apparatus irradiates the honeycomb molded body with microwaves in an alternating manner from the upper side and the lower side and carries out a hot air drying in parallel with irradiation of the microwaves.

The method for manufacturing a honeycomb structure according to the embodiments of the present invention includes drying to be carried out on the manufactured honeycomb molded body, and because in this process microwaves are irradiated to the honeycomb molded body in an alternating manner from the upper side and the lower side while applying hot air in parallel with the microwave irradiation, to the honeycomb molded body, it becomes easier to achieve uniform drying of the ceramic molded body, and because of this, warpage or the like becomes less likely to occur in the honeycomb molded body after drying.

Because of this, it is possible to manufacture a honeycomb molded body of a prescribed shape with the method for manufacturing a honeycomb structure according to the embodiments of the present invention.

Also, because it becomes easier to achieve uniform drying of the honeycomb molded body with the method for manufacturing a honeycomb structure according to the embodiments of the present invention, it is possible to manufacture a honeycomb structure including a honeycomb fired body having a high degree of strength.

Firstly, description will be given in regard to the drying apparatus and the method for drying a ceramic molded body according to the embodiments of the present invention.

It is possible for the method for drying a ceramic molded body according to the embodiments of the present invention to optimally use the drying apparatus according to the embodiments of the present invention.

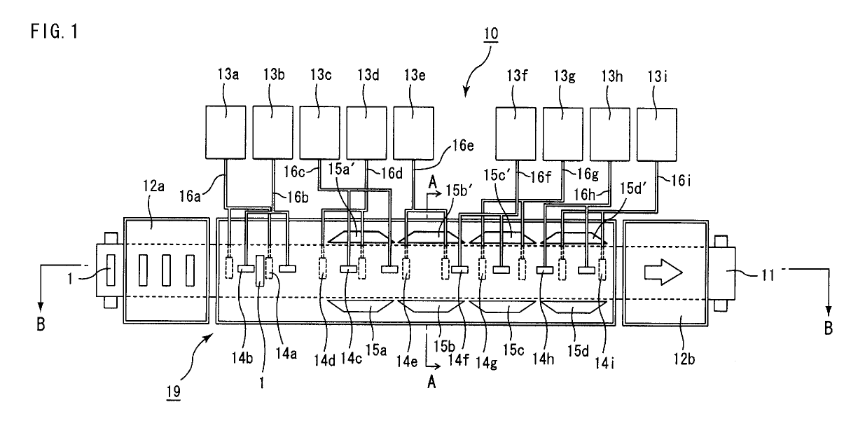

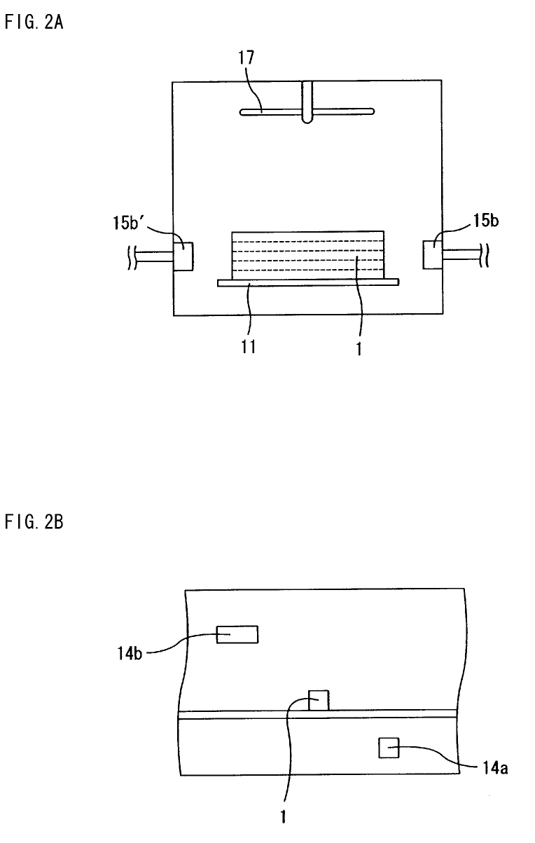

FIG. 1 is a plan view showing a general representation of an embodiment of the drying apparatus of the present invention. FIG. 2A is a partial cross-sectional view of the embodiment of the drying apparatus taken along line A-A in FIG. 1, and FIG. 2B is a partial cross-sectional view of the embodiment of the drying apparatus taken along line B-B in FIG. 1.

As shown in FIG. 1, a drying apparatus 10 includes: a drying furnace main body 19 including a conveying member (belt conveyor) 11 for conveying an item to be dried 1; microwave irradiation portions 14a to 14i disposed alternately at an upper side and a lower side with respect to the belt conveyor 11; a plurality of hot air blowing portions 15a to 15d established at a low position in a manner crawling along the floor and close to the belt conveyor 11, and hot air aspiration portions 15a′ to 15d′; microwave transmission portions 13a to 13i joined to the microwave irradiation portions 14a to 14i by waveguide tubes 16a to 16i; and microwave leak prevention regions 12a and 12b disposed at the entrance side and exit side of the drying furnace main body 19 for the purpose of preventing the leakage of microwaves.

Therefore, with the drying apparatus 10 it becomes easier to carry out microwave irradiation on the item to be dried such as a ceramic molded body 1 from the upper side and the lower side alternately.

Moreover, as is shown in FIGS. 2A and 2B, the drying furnace main body 19 includes a microwave agitation blade 17 disposed on a ceiling portion of the drying furnace main body 19 for the purpose of uniformly irradiating microwaves from the microwave irradiation portions 14a to 14i to the item to be dried.

Therefore, according to the rotation of the microwave agitation blade 17, it becomes easier to irradiate microwaves to the item to be dried in a uniform manner. Moreover, it is acceptable that the microwave agitation blade be provided in the drying apparatus according to the embodiments of the present invention according to necessity.

Also, although the number of blade units or the location of installation of the microwave agitation blade 17 (not shown in FIG. 1) is not particularly limited, it is preferable that it be installed near the microwave irradiation portions (14b, 14c, 14f, 14h) used for the purpose of irradiating microwaves from the upper side with respect to the item to be dried.

In the drying apparatus 10, upon placing of the ceramic molded body 1 onto the belt conveyor 11, the ceramic molded body 1 is conveyed into the interior of the drying apparatus 10 through the entryway, and after a prescribed period of time has passed, is conveyed out through the exit of the drying apparatus 10.

Here, the belt conveyor 11 is set to move in an intermittent manner.

More specifically, the belt conveyor 11 is set in a manner so as to carry out a repeated operation of moving at a prescribed speed for a prescribed period of time, then stopping momentarily for a prescribed period of time, and then moving again at a prescribed speed for a prescribed period of time. And for example, the belt conveyor 11 is set in such a manner that the hot air of the hot air blowing portions 15a to 15d inside of the drying apparatus 10 directly contacts the stationary ceramic molded body 1 in a direction parallel to a longitudinal direction of the ceramic molded body 1.

Moreover, in the drying apparatus according to the embodiments of the present invention, it is not necessarily essential that the belt conveyor 11 (the conveying member for conveying an item to be dried) move intermittently, as it is also acceptable that the belt conveyor 11 be set to move continuously at a constant or varying speed.

Also, in the drying apparatus 10, the hot air aspiration portions 15a′ to 15d′ and the hot air blowing portions 15a to 15d are disposed in an opposing manner, and because of this, it is possible to blow the hot air along the longitudinal direction of the ceramic molded body in a more precise manner.

It is not, however, absolutely essential that the above mentioned hot air aspiration portions be provided.

The method for drying a ceramic molded body according to an embodiment of the present invention can be carried out using the drying apparatus according to the embodiments of the present invention.

Here, description will be given in regard to desirable drying conditions and the like using as an example a case of using a pillar-shaped honeycomb molded having a multiplicity of cells placed in parallel with one another in a longitudinal direction with a cell wall therebetween as the ceramic molded body serving as the item to be dried.

It is a matter of course that the item to be dried in the drying method according to the embodiments of the present invention is not limited to being a honeycomb molded body, as various kinds of ceramic molded bodies may also serve as items to be dried.

In the present specification, the shape indicated by the word “pillar” refers to any desired shape of a pillar including a round pillar, an oval pillar, a polygonal pillar and the like.

In the drying method according to the embodiments of the present invention, microwaves are irradiated alternately from the upper side and the lower side with respect to the honeycomb molded body while hot air drying is conducted in parallel with irradiation of microwaves.

In this manner, according to irradiating microwaves alternately from the upper side and the lower side with respect to the honeycomb molded body, because the moisture located throughout the honeycomb molded body becomes easier to be eliminated uniformly, warpage or the like becomes less likely to occur in the honeycomb molded body after drying. Also, because hot air drying is carried out in parallel with the microwave irradiation, it is possible to avoid the inconvenience of warpage had in cases of drying according to only microwave irradiation, as cases of drying according to only microwave irradiation have a trend of it being difficult to achieve a dried state at areas near the central portion of the honeycomb molded body, and as a result there is a concern that there will be slight generation of warpage in the honeycomb molded body more easily. Moreover, in light of the above, it is preferable that the ceramic molded body dried with the drying method according to the embodiments of the present invention be the above mentioned honeycomb molded body.

Also, the drying apparatus 10 shown in FIG. 1 includes four microwave irradiation portions (14b, 14c, 14f, 14h) for the purpose of irradiating microwaves from the upper side with respect to the honeycomb molded body, and five microwave irradiation portions (14a, 14d, 14e, 14g, 14i) for the purpose of irradiating microwaves from the lower side with respect to the honeycomb molded body. The number of microwave irradiation portions for the purpose of irradiating microwaves from the lower side with respect to the honeycomb molded body is greater than the number of microwave irradiation portions for the purpose of irradiating microwaves from the upper side with respect to the honeycomb molded body. The reason for this is that in a case in which microwaves are irradiated to the honeycomb molded body from the lower side, microwaves must pass through the belt conveyor to irradiate the honeycomb molded body, which tends to lead to difficulty in drying the bottom of the honeycomb molded body.

It is however acceptable for the number of the microwave irradiation portions at the upper side and the lower side to be the same, and it is also acceptable for the number of the microwave irradiation portions disposed at the upper side to be greater than that of the lower side.

It is also acceptable to have the number of the microwave irradiation portions at the upper side and the lower side to be the same while having the microwaves irradiated from the lower side with respect to the honeycomb molded body set to a higher power.

Although the specific number of the above mentioned microwave irradiation portions is not particularly limited, it is preferable that there be two or more microwave irradiation portions disposed at the upper side with respect to the item to be dried and three or more microwave irradiation portions disposed at the lower side with respect to the item to be dried.

Also, while it is not possible to indiscriminately regulate the conditions of power and the like of the microwaves in the drying method according to the embodiments of the present invention due to the conditions and the like being dependant upon factors such as the shape and size of the ceramic molded body or the like, which is the subject of drying (the item to be dried), it is for example desirable for the power of the microwave irradiated from each microwave irradiation portion to be at least about 3 kW and at most about 7 kW, and even more desirable at about 5 kW, in a case of drying a honeycomb molded body (ceramic molded body) which is to become a honeycomb fired body having a dimension of about 33 mm×about 33 mm×about 300 mm, the number of cells of about 31 pcs/cm², and cell wall thickness of about 0.35 mm after firing.

Also, as has already been described, although it is acceptable for the honeycomb molded body to be moved by the belt conveyor either intermittently or continuously, it is desirable that it be moved intermittently. And in such a case, it is preferable that the movement speed of the belt conveyor is at least about 2 m/min and at most about 8 m/min. Also, it is preferable that the period of time over which the belt conveyor is stopped be at about two seconds. Moreover, the movement speed of the above mentioned belt conveyor is not differentiated according to moving time and stopping time, but is calculated as the amount of movement per unit of time.

Also, it is preferable that the period of time (drying time) over which the honeycomb molded body exists inside of the drying apparatus be at least about 2 minutes and at most about 3 minutes. If the drying time is about two minutes or more, it becomes easier for drying to be sufficient, and on the other hand if the drying time is about three minutes or less, drying does not progress excessively and warpage and the like becomes less likely to occur.

Also, in the drying method according to the embodiments of the present invention, it is preferable that the moisture content of the ceramic molded body (honeycomb molded body) after drying is about 30% by weight or more and less than about 70% by weight of the moisture content before drying.

If the moisture content after drying is about 30% by weight or more of the moisture content before drying, the moisture content within the honeycomb molded body is less likely to be insufficient, and warpage, cracks, or the like become less likely to occur in the honeycomb molded body. And furthermore, if the moisture content is reduced to less than 30% by weight, the microwaves come to be absorbed into the ceramic powder leading to a sudden rise in the temperature of the ceramic powder within the honeycomb molded body which thereby starts degreasing. Alternately, if the moisture content after drying is about less than 70% by weight of the moisture content before drying, drying is less likely to become insufficient, which leads to an improvement of the degree of handleability.

It is possible to adjust the moisture content achieved during the drying method by adjusting the drying time, the power of the microwaves, the temperature of the hot air, and the like.

Also, in the drying method according to the embodiments, it is preferable that the temperature of the hot air is at least about 40° C. and at most about 80° C. This is because at a temperature of about 40° C. or more, it becomes easier to enjoy the effects attained by the additional use of the hot air that has been described herein above. And alternately, at a temperature of about 80° C. or less, state of drying does not progress sharply, and warpage, cracks, and the like become less likely to occur in the ceramic molded body (honeycomb molded body).

Moreover, it is preferable that the airspeed of the above mentioned hot air is at least about 20 m/sec and at most about 40 m/sec.

If the above mentioned airspeed is about 20 m/sec or more, the drying speed does not become slow, making it less likely to give rise to occurrences of drying variation in the ceramic molded body. And if the above mentioned airspeed is about 40 m/sec or less, drying is less likely to progress at only the surface of the ceramic molded body, and the overall drying becomes more likely to progress.

By using this kind of drying method, it becomes easier to dry the ceramic molded body in a manner setting the moisture content thereof to a desired amount and without occurrences of warpage or cracks.

Next, description will be given in regard to the method for manufacturing a honeycomb structure of the present invention.

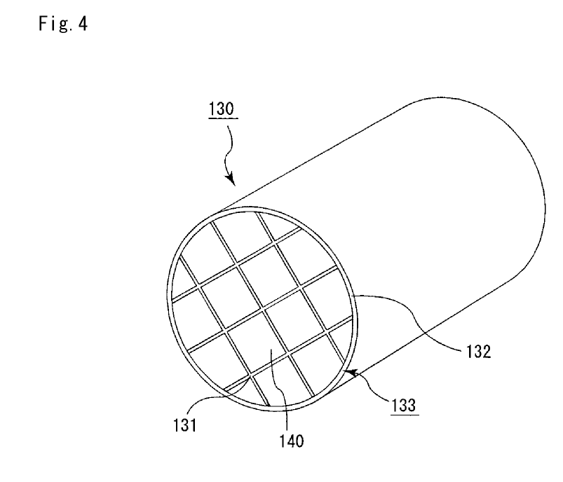

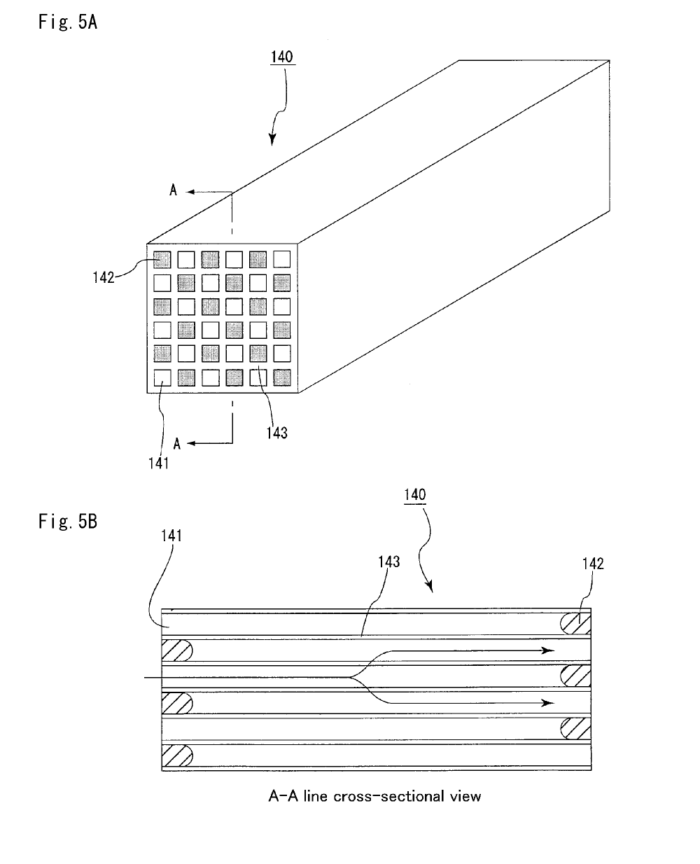

FIG. 4 is a perspective view schematically showing an embodiment of a honeycomb structure according to the invention. FIG. 5A is a perspective view schematically showing a honeycomb fired body which forms the above mentioned honeycomb structure according to the embodiment, while FIG. 5B is a cross-sectional view taken along line A-A thereof.

Normally, in a honeycomb structure 130, a plurality of honeycomb fired bodies 140 of the kind shown in FIGS. 5A and 5B, are bound together by interposing a sealing material layer (an adhesive layer) 131 forming a ceramic block 133, and a sealing material layer (a coat layer) 132 is further formed on the periphery of the ceramic block 133. In the honeycomb fired body 140, as shown in FIG. 4, a multitude of cells 141 are placed in parallel with one another in the longitudinal direction, and a cell wall 143, which separates the cells 141 from one another is allowed to function as a filter.

More specifically, as shown in FIG. 5B, the end portion of either the exhaust gas inlet side or the exhaust gas outlet side of the cells 141 formed in the honeycomb fired body 140 is sealed by a plug material layer 142. Therefore, exhaust gases entering one cell 141 will always pass through the cell wall 143 separating the cells 141 and thus flow out through another one of the cells 141. When the exhaust gases pass through the cell wall 143, particulates contained within the exhaust gases are captured by the cell wall 143, thereby purifying the exhaust gases.

Because this kind of honeycomb structure 130 includes honeycomb fired bodies 140 that are made of silicon carbide and thus excel extremely in thermal resistance and are easily regenerated, it is used in various types of large scales vehicles and diesel engine equipped vehicles and the like.

Hereinbelow, description will be set forth in regard to the method for manufacturing a honeycomb structure according to the embodiments of the present invention, in process order.

At this point, using as an example a case of manufacturing a honeycomb structure having silicon carbide as a main component, description will be put forth in regard to an embodiment of the method for manufacturing a honeycomb structure according to the present invention.

It is a matter of course that the main component of the constituent material of the honeycomb structure is not limited to silicon carbide. Other examples of the material include for instance, components such as nitride ceramics such as aluminum nitride, silicon nitride, boron nitride, titanium nitride; carbide ceramics such as zirconium carbide, titanium carbide, tantalum carbide, tungsten carbide; and oxide ceramics such as alumina, zirconia, cordierite, mullite, and aluminum titanate, and the like.

Out of the above mentioned possible components, non-oxide ceramics are desirably used, with silicon carbide being particularly desirable. This is because they are excellent in thermal resistance properties, mechanical strength, and thermal conductivity. Moreover, silicon-containing ceramic, which is had by infusing metallic silicon with the ceramics set forth above, as well as ceramic bound by silicon or silicate compounds can also be used as the constituent material of the honeycomb structure. And out of these, those (silicon-containing silicon carbide) of silicon carbide with metallic silicon are preferable.

First, organic binder is dry mixed with an inorganic powder such as silicon carbide powder having a varying average particle diameter as a mixed powder. While the mixed powder is being prepared, a mixed solution is prepared of blended liquid plasticizer, lubricant, and water. Next, the above mentioned mixed powder and the above mentioned mixed solution are further blended together using a wet mixing machine, and thus a wet mixture for use in manufacturing the molded body is prepared.

Although the particle diameter of the above mentioned silicon carbide powder is not particularly limited, the silicon carbide powder that tends not to cause the case where the size of the honeycomb structure manufactured by the following firing treatment becomes smaller than that of the honeycomb molded body after degreased is preferable. For example, a powder mix of 100 parts by weight of a powder having an average particle diameter of at least about 0.3 μm and at most about 50 μm, and at least about 5 parts by weight and at most about 65 parts by weight of another powder having an average particle diameter of at least about 0.1 μm and at most about 1.0 μm, is desirable.

Although it is necessary to adjust the firing temperature in order to adjust the pore diameter of the honeycomb molded body, the pore diameter can also be adjusted by adjusting the particle diameter of the inorganic powder.

The above mentioned organic binder is not limited in particular, and binders such as methylcellulose, carboxymethyl cellulose, hydroxyethyl cellulose, polyethylene glycol, for example, are acceptable for use therein. Of the binders mentioned above, methylcellulose is the more preferable.

It is preferable that the above mentioned binder be blended with the inorganic powder at a ratio of at least about 1 part by weight and at most about 10 parts by weight per 100 parts by weight of inorganic powder.

The above mentioned plasticizer is not limited in particular, and substances such as glycerin, for example, are acceptable for use as such.

The above mentioned lubricant is not limited in particular, and substances such as polyoxyalkylene-based compounds such as polyoxyethelyne alkyl ether, and polyoxypropylene alkyl ether, for example, are acceptable for use as such.

Some concrete examples of lubricants are substances such as polyoxyethelyn monobutyl ether, and polyoxypropylene monobutyl ether.

Also, in some cases, it is unnecessary to use plasticizer or lubricant in the mixed material powder.

Also, when preparing the above mentioned wet mixture, it is acceptable to use a dispersant such as water, organic solvents such as benzol, and alcohol such as methanol and the like, for example.

Further, it is also acceptable to add a mold aiding agent to the above mentioned wet mixture.

The mold aiding agent is not limited in particular, and substances such as ethylene glycol, dextrin, fatty acids, fatty acid soap, or poly alcohol, for example, may be used.

Further, according to need, a pore-forming agent such as balloon that is a micro sized hollow sphere having oxide-based ceramic as a component therein, spherical acrylic particle, or graphite, may be added to the above mentioned wet mixture.

The above mentioned balloon is not particularly limited, and alumina balloons, glass micro balloons, shirasu balloons, fly ash balloons (FA balloons), mullite balloons and the like, for example, are all acceptable for use. Of the above mentioned, alumina balloon is the more preferable for use.

Also, it is preferable for the temperature of the above prepared wet mixture, which uses silicon carbide powder, to be about 28° C. or less. This is because if the temperature is about 28° C. or less, organic binder becomes less likely to undergo gelatinization.

It is also preferable for the inorganic ratio of within the above mentioned wet mixture to be about 10% by weight or less, and it is also preferable for the moisture content weight of the same wet mixture to be at least about 8.0% by weight and at most about 20.0% by weight.

After preparation, the above mentioned wet mixture is inducted into an extrusion-molding machine, and according to extrusion-molding, a pillar-shaped honeycomb molded having a multiplicity of cells placed in parallel with one another in the longitudinal direction with a cell wall therebetween is produced.

Afterward, drying of a molded body is carried out on this honeycomb molded body by placing it onto a conveying member which thereby passes the honeycomb molded body through the interior of the drying apparatus in a prescribed period of time, so that the honeycomb molded body is dried.

Here, the honeycomb molded body is dried by using the drying method according to the embodiments of the present invention which uses the drying apparatus according to the embodiments of the present invention. And since the embodiments of the drying method has already been described in detail herein above, that same detailed description will be omitted at this point.

And, because the above mentioned drying method according to the embodiments of the present invention is employed into use in the present process in the method for manufacturing a honeycomb structure according to the embodiments of the present invention, it becomes easier to dry the honeycomb molded body uniformly and without occurrences of warpage and the like regardless of the composition (the kind of ceramic, the kind of binder or the like) of the wet mixture constituting the honeycomb molded body.

Also, in the above mentioned drying of a molded body, it is preferable that the moisture content of the honeycomb molded body after drying is about 30% by weight or more and less than about 70% by weight of the moisture content before drying.

In the present process, according to drying the honeycomb molded body, the degree of handleability of the honeycomb molded body was difficult due to the honeycomb molded body being easily prone to deformation due to the moisture content of the honeycomb molded body of directly after molding being high. In contrast to this, in the present process, according to drying the honeycomb molded body, thereby reducing the moisture content in the molded body, the degree of handleability has been improved. Because of this, in the present process, it is preferable that the moisture content of the honeycomb molded body after drying be set to less than about 70% by weight of the moisture content before drying.

Also, the reason that it is preferable to set the moisture content of the above mentioned honeycomb molded body after drying to about 30% by weight or more is that if the moisture amount is reduced to below this amount there arises the concern of the occurrence of warpage, cracks, or the like in the honeycomb molded body, and furthermore, the microwaves come to be absorbed into the ceramic powder leading to a sudden rise in the temperature of the ceramic powder within the honeycomb molded body which thereby starts degreasing.

It is also preferable in the above mentioned drying of a molded body, that the temperature of the hot air is at least about 40° C. and at most about 80° C. The reason for this is as was set forth herein above.

Next, it is preferable to further carry out drying in order to nearly completely eliminate the moisture within the above mentioned honeycomb molded body, and here, in the state of the honeycomb molded body being held by a drying jig, it is preferable to carry out drying using a hot air drying apparatus.

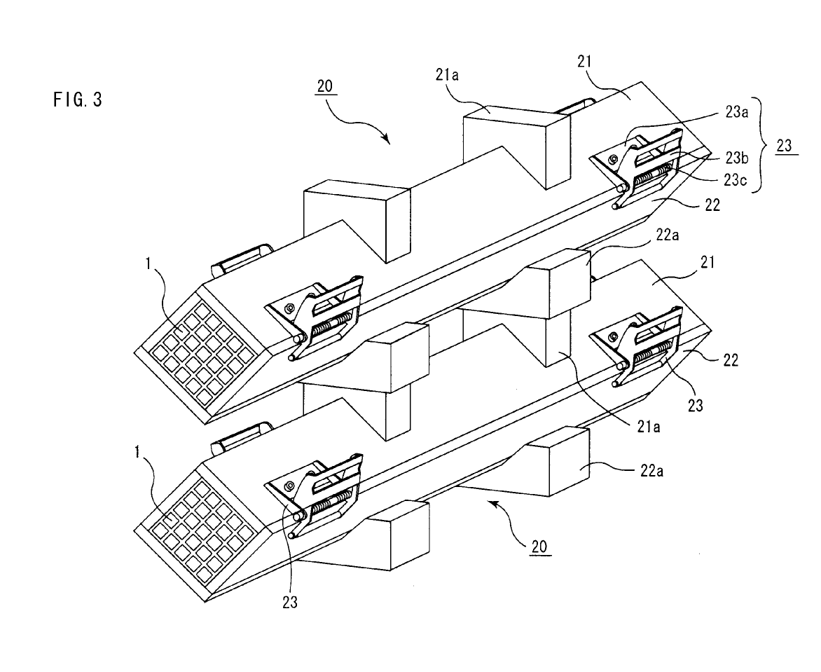

FIG. 3 is a perspective view schematically showing an example of the drying jig according to the embodiments of the present invention.

As shown in FIG. 3, a drying jig 20 includes two jigs, a top jig 21 and a bottom jig 22. The top jig 21 is fabricated in a manner joining the long sides of two long and thin plate shaped bodies in a manner such that their main faces are orthogonal, and the bottom jig 22 has a shape identical to the top jig 21. Disposed to the top jig 21, as shown in FIG. 3, is a fixing member 23 for the purpose of fixing the top jig 21 and the bottom jig 22 after they have been combined. It is acceptable to dispose the fixing member onto the top jig, as it is also acceptable to dispose the fixing member onto the bottom jig.

This fixing member 23 includes a fixing piece 23a fixed onto the plate shaped body using a screw, and a holding piece 23b installed via a spring 23c onto the fixation piece 23a in a rotatable manner. As is shown in FIG. 3, the fixing member 23 can exist in a fixed state in which the holding piece 23b holds down the bottom jig 22 thus fixing it in place, as well as a released state in which the holding piece 23b is collapsed in a direction roughly identical to the fixing piece 23a. In the fixation member 23, if the top end of the holding piece 23b in the released state is moved a certain distance toward the outside (in the direction running away from the fixing piece 23a) the holding piece 23b switches to the fixed state to firmly hold down and fix the bottom jig 22 in place. Alternately, if the holding piece 23b in the fixed state is moved a certain distance toward the inside (in the direction nearing the fixation piece 23a), the holding piece 23b switches to the released state.

As has been set forth herein above, in the drying used for the purpose of nearly completely eliminating the moisture within the honeycomb molded body, it is preferable to conduct a drying treatment in which the honeycomb molded body 1 is held by a drying jig 20 of the kind shown in FIG. 3.

By using this kind of drying jig in a state of the drying jig compressing the honeycomb molded body from the sides while fixing it in place so that the shape does not change, it becomes easier to carry out drying on the honeycomb molded body in such a state that there is almost no moisture therein as well as no occurrence of warpage and the like.

And although the drying jig 20 shown in FIG. 3 includes two separatable jig members, the drying jig used in the present invention can also be comprised of a single openable and closable jig member.

And it is also acceptable that the above mentioned drying jig be able to be used in a manner stacked in multiple levels such as two levels, as it is also acceptable for it to be used as a single level only.

Next, cells are sealed according to need. Here, a prescribed amount of plug material paste, which becomes the actual plug, is filled into the end portions of the outlet sides of the inlet side cell group, as well as the end portions of the inlet sides of the outlet side cell group.

Although the above mentioned plug material paste is not particularly limited, it is preferable that the plug manufactured through the subsequent processes exhibits a porosity in the range of at least about 30% and at most about 75%. It is for instance, possible to use a material that is the same as the above mentioned wet mixture as the plug material paste.

It is acceptable to carry out filling of the above mentioned plug material paste according to necessity, and in a case of carrying out filling of the above mentioned plug material paste, it is possible to use the honeycomb structure attained through the subsequent processes optimally as a honeycomb filter, for instance. And in a case of not having had filled the above mentioned plug material paste into the cells, it is possible to use the honeycomb structure attained through the subsequent processes optimally as a catalyst supporting carrier, for instance.

Next, by carrying out degreasing (at least about 200° C. and at most about 500° C., for example) and firing (at least about 1400° C. and at most about 2300° C., for example) under prescribed conditions on a honeycomb molded body in which with the above mentioned plug material paste is filled, it is possible to manufacture a pillar shaped honeycomb fired body in which one of the end portions of the above mentioned cells are plugged, and a multitude of cells are placed in parallel with one another in the longitudinal direction with a cell wall therebetween.

The above mentioned conditions under which degreasing and firing are executed to the above mentioned honeycomb molded body can be the same conditions that have been used conventionally when manufacturing a filter comprised of porous ceramic.

Next, a sealing material paste, which becomes the sealing material layer (the adhesive layer) is applied to the side surfaces of the honeycomb fired body in a uniform thickness. After this, another honeycomb fired body is successively stacked to the sealing material paste layer. By carrying out the above process repeatedly, an aggregate of honeycomb fired bodies having a prescribed size is produced.

It is possible to use a substance such as a substance containing inorganic fiber and/or inorganic particle in addition to inorganic binder, organic binder, for example, as the above mentioned sealing material paste.

It is acceptable to use silica sol, alumina sol, and the like, for example, as the above mentioned inorganic binder. Also, it is acceptable to use the above singly, or use a combination of two or more of them in parallel. Of the above mentioned inorganic binders, silica sol is most preferable for use.

It is acceptable to use polyvinyl alcohol, methylcellulose, ethylcellulose, carboxy methylcellulose, and the like, for example, as the above mentioned organic binder. Also, it is acceptable to use the above singly, or use a combination of two or more of them in parallel. Of the above mentioned organic binders, carboxy methylcellulose is most preferable for use.

It is acceptable to use ceramic fibers such as silica-alumina, mullite, alumina, silica, for example, as the above mentioned inorganic fiber. Also, it is acceptable to use the above singly, or use a combination of two or more of them in parallel. Of the above mentioned inorganic fiber, alumina fiber is most preferable for use.

It is acceptable to use carbide, nitride, and the like, for example, as the above mentioned inorganic particle. More specifically, it is acceptable to use inorganic powder and the like including silicon carbide, silicon nitride, boron nitride, or the like, for example, as the above mentioned inorganic particle. It is acceptable to use the above singly, or use a combination of two or more of them in parallel. Of the above mentioned inorganic particle, silicon carbide, which excels in its thermal conductivity properties, is most preferable for use.

And furthermore, according to need, a pore-forming agent such as balloon that is a micro sized hollow sphere having oxide based ceramic as a component therein, spherical acrylic particle, or graphite and the like, may be added to the above mentioned sealing material paste.

The above mentioned balloon is not particularly limited, and alumina balloon, glass micro balloon, shirasu balloon, fly ash balloon (FA balloon), mullite balloon, and the like, for example, are all acceptable for use. Of the above mentioned, alumina balloon is the most preferable for use.

Next, this aggregate of honeycomb fired bodies is heated to dry the sealing material paste layer, which then hardens to become the sealing material layer (the adhesive layer).

Next, using a diamond cutter or the like, cutting is carried out on the aggregate of honeycomb fired bodies, which includes a plurality of honeycomb fired bodies adhered together by interposing the sealing material layer (the adhesive layer), thereby producing a round pillar-shaped ceramic block.

Afterward, another sealing material layer (a coat layer) is formed by coating the above mentioned sealing material paste to the outer periphery of the ceramic block. Thus, a honeycomb structure having the sealing material layer (the coat layer) formed on the outer peripheral portion of a round pillar-shaped ceramic block including a plurality of honeycomb fired bodies adhered together by interposing the sealing material layer (the adhesive layer) is manufactured.

Afterward, a catalyst is supported on the honeycomb structure as needed. It is also acceptable to support the above mentioned catalyst onto the honeycomb fired bodies, before the honeycomb fired bodies are manufactured into the honeycomb molded body aggregate.

In a case where the catalyst is supported, it is preferable that a film of alumina, which has a high specific surface area, be formed onto the surface of the honeycomb structure, and a co-catalyst and a catalyst such as platinum and the like is adhered to the surface of the alumina film.

It is acceptable to apply a method of impregnating the honeycomb structure with a metallic compound containing an aluminum species such as Al(NO₃)₃ and the like, for example, and then heating, or a method of impregnating the honeycomb structure with a solution containing alumina powder and then heating and other methods, as a method of forming the alumina film onto the surface of the above mentioned honeycomb structure.

It is acceptable to apply a method of impregnating the honeycomb structure with a metallic compound containing a rare earth element such as Ce(NO₃)₃ and the like, for example, and then heating, as a method of administering the co-catalyst onto the above mentioned alumina film.

It is acceptable to apply a method of impregnating the honeycomb structure with a substance such as a dinitrodiammine platinum nitric acid solution ([Pt(NH₃)₂(NO₂)₂]HNO₃, platinum content of about 4.53% by weight) and the like, for example, and then heating and other methods, as a method of adhering the catalyst onto the above mentioned alumina film.

Also, it is acceptable that the catalyst is adhered with a method of first adhering the catalyst to alumina particles in advance, and subsequently impregnating the honeycomb structure with the solution containing the alumina powder, to which the catalyst has been adhered in advance.

In the method for manufacturing a honeycomb structure according to the embodiments put forth up to this point, although the honeycomb structure has been a honeycomb structure (also termed “aggregated honeycomb structure” hereinafter) having a form of a plurality of honeycomb fired bodies according to the embodiments bound together by interposing the sealing material layer (the adhesive layer), the honeycomb structure manufactured according to the method for manufacturing a honeycomb structure according to the embodiments of the present invention can also be a honeycomb structure (also termed “integral honeycomb structure” hereinafter) having a form of a honeycomb fired body configured as a single round pillar-shaped ceramic block.

In a case of manufacturing an integral honeycomb structure of this sort, the only aspect that is different than a case of manufacturing the aggregated honeycomb structure is that the size of the honeycomb molded body, that is extrusion molded, is larger in the case of manufacturing an integral honeycomb structure than that in the case of manufacturing an aggregated honeycomb structure, and all other aspects used to manufacture an integral honeycomb structure are identical to those used in manufacturing an aggregated honeycomb structure.

At this point, because the methods and the like by which the wet mixture of before molding is conveyed and stored are identical to those in the method of manufacturing the above mentioned aggregated honeycomb structure, description thereof will be omitted.

Next, in the same manner as in the method of manufacturing an aggregated honeycomb structure, the above mentioned honeycomb molded body is dried out using the drying method of the present invention employing the drying apparatus of the present invention. Moreover, according to need, it is acceptable to carry out the drying for the purpose of nearly completely eliminating the moisture from the honeycomb molded body. Next, cells are sealed by filling a prescribed amount of plug material paste into the end portions of the outlet sides of the inlet side cell group, as well as the end portions of the inlet sides of the outlet side cell group.

Afterward, in the same manner as in the manufacture of the aggregated honeycomb structure, degreasing and firing are carried out, thereby producing a ceramic block. And according to need, it is possible to form the sealing material layer (the coat layer). Thus, an integral honeycomb structure is manufactured. Further, it is also acceptable to support a catalyst on the above mentioned integral honeycomb structure with the method put forth herein above.

In the case of manufacturing the honeycomb structure according to the method for manufacturing a honeycomb structure according to the embodiments set forth herein above, when manufacturing the above mentioned aggregated honeycomb structure, it is desirable to use silicon carbide or silicon-containing silicon carbide powder as the main component of the constituent material, and when manufacturing the integral honeycomb structure it is desirable to use cordierite or aluminum titanate as the main component of the constituent material.

Also, although description has been centered mainly around the honeycomb filter, for the purpose of capturing particulates in the exhaust gases, as the honeycomb structure, the above mentioned honeycomb structure can also be used suitably as a catalyst supporting carrier (honeycomb catalyst) for converting exhaust gases.

With the herein above described method for manufacturing a honeycomb structure according to the embodiments of the present invention, it becomes easier to optimally manufacture a honeycomb structure having a prescribed shape.

### EXAMPLES

Herein below examples will be set forth describing the present invention in further detail, though it should be understood that the present invention is not limited to these examples.

### Example 1

(1) First, 250 kg of α-type silicon carbide powder having an average particle diameter of 10 μm, 100 kg of α-type silicon carbide powder having an average particle diameter of 0.5 μm, and 20 kg of organic binder (methylcellulose) were blended together to prepare a powder mixture.

Next, 12 kg of lubricant (UNILUB, manufactured by NOF Corp.), 5 kg of plasticizer (glycerin), and 65 kg of water were blended in a separate container to prepare a liquid mixture. Next, using a wet mixing machine, the powder mixture and the liquid mixture were blended together, thereby preparing the wet mixture.

Next, extrusion-molding using this wet mixture, and cutting following the extrusion-molding was carried out, and thereby a honeycomb molded body was produced.

(2) Next, the above mentioned honeycomb molded body was dried using the drying apparatus 10 shown in FIGS. 1 and 2, wherein the moisture content (remaining moisture ratio) of the honeycomb molded body was set to 50% by weight of the moisture content before drying.

More specifically, the above mentioned honeycomb molded body was dried by running a repeated operation of moving the belt conveyor 11 for two seconds at a speed of 4.5 m/min through the interior of the drying furnace main body 19 which has a movement distance of 15 m, and then stopping the belt conveyor 11 for two seconds, whereby the honeycomb molded body was conveyed intermittently, during which, the honeycomb molded body was dried by irradiating 5.0 kW microwaves from each of the microwave irradiation portions disposed at the upper side and the lower side with respect to the drying furnace interior while blowing 50° C. hot air at an airspeed of 30 m/sec from each of the hot air blowing portions.

Also, the remaining moisture ratio of the honeycomb molded body was calculated based on the mass change of the moisture content of before and after drying.

(3) Next, a drying treatment in the manner below was carried out.

The honeycomb molded body was held by the drying jig (made of epoxy resin) shown in FIG. 3, and drying was carried out by carrying in this drying jig in a state of it being stacked as two levels into a hot air drying apparatus.

The drying conditions here were as follows: the temperature of the interior of the drying apparatus was set to a 100° C.; and the time spent inside of the drying apparatus was set to 15 minutes.

(4) Next, the honeycomb molded body on which the above mentioned drying treatment had been carried out was removed from the drying jig, and a plug material paste having a constitution identical to the above mentioned wet mixture was filled into prescribed cells.

Next, after carrying out further drying by using a drying apparatus, degreasing was carried out at 400° C., and firing was carried out for three hours at atmospheric pressure in an argon atmosphere at 2200° C., thereby manufacturing a honeycomb sintered body made from a silicon carbide sintered body having a porosity of 40%, an average pore diameter of 12.5 μm, dimensions of 34.3 mm×34.3 mm×305 mm, the number of cells (cell density) of 46.5 pcs/cm², and a cell wall thickness of 0.25 mm.

### Examples 2 to 10, Reference Examples 1 to 5

In the process (2) of Example 1, aside from the point of having changed the drying conditions to those indicated in Table 1, and having produced the honeycomb molded body exhibiting a moisture after drying with respect to the moisture content before drying of the value indicated in Table 1, the honeycomb fired body was manufactured in a manner identical to the Example 1.

### Comparative Example 1

In the process (2) of Example 1, when drying the honeycomb molded body using the drying apparatus 10, aside from the point of irradiating microwaves from only the microwave irradiation portions (14b, 14c, 14f, 14h) disposed at the upper side with respect to the conveyor member (the belt conveyor 11) to dry the honeycomb molded body with the conditions indicated in Table 1, the honeycomb fired body was manufactured in a manner identical to the Example 1.

In this Comparative Example, it can be said that irradiation of the microwaves is carried out only from the upper side with respect to the honeycomb molded body.

For each Example (Ex.), Reference Example (Ref. Ex.), and Comparative Example (Comp. Ex.), after the honeycomb molded body is dried, the handleability of the molded body after drying was evaluated with the method set forth below, and furthermore, the amount of warpage of the produced honeycomb fired body was measured. The results are shown in Table 1.

(Evaluation of Handleability)

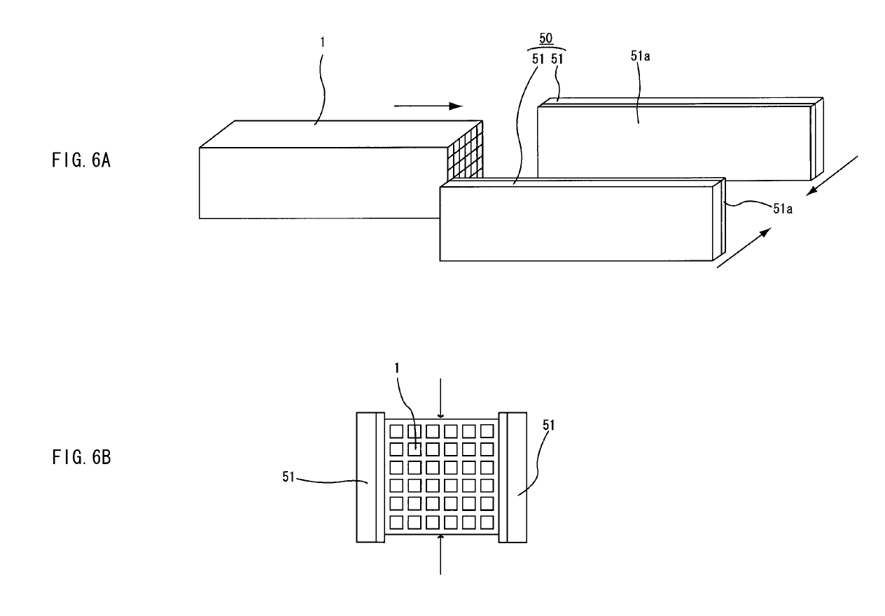

An evaluation of the handleability of the honeycomb molded body was conducted using a handleability evaluation jig (see FIGS. 6A and 6B).

As an evaluation tool, a handleability evaluation jig 50 was used. The handleability evaluation jig 50 is constituted by two flat plate shaped bodies 51 that are slightly larger than the side faces of the honeycomb molded body 1, each plate shaped body having a urethane layer 51a formed on the entirety of one of the main faces, wherein the two urethane layers 51a face each other.

And in the evaluation, first, the honeycomb molded body 1 was placed between the two plate shaped bodies 51, after which each one of the above mentioned plate shaped bodies 51 is pressed to the corresponding parallel side face of the honeycomb molded body 1 at a pressure of 2 kPa to thereby sandwich the honeycomb molded body 1. Afterward, the amount of deformation of the honeycomb molded body 1 was measured and handleability was thereby evaluated with the following evaluation standard.

That is, in a state sandwiching the honeycomb molded body 1 with the two plate shaped bodies 51 as shown in FIG. 6B, with respect to the end face of the honeycomb molded body 1, the length (the length of the portion sandwiched by the arrows in FIG. 6B) of a portion therein which has an equal distance from the main faces of each of the two plate shaped bodies was measured, and the measured length was compared with the length of the same portion of the honeycomb molded body before being sandwiched by the two plate shaped bodies 51 and the difference in the length was referred to as the amount of deformation.

As the evaluation standard, “++” represents absolutely no deformation, “+” represents an amount of deformation of less than 1 mm, and “−” represents an amount of deformation of 1 mm or more.

(Measurement of the Amount of Warpage)

Measurement of the amount of warpage of the honeycomb fired body was carried out using a warpage amount measurement jig.

The warpage amount measurement jig is constituted by a straight block member having a length roughly identical to the full length of the honeycomb fired body, and contact members of the same thickness established on both ends of the block member, and has installed on the center of this block member a scale (a scale for warpage measurement) slidable in the direction perpendicular to the longitudinal direction of the above mentioned block member.

And during measurement, the above mentioned contact members are made to contact near both ends of the dried honeycomb fired body, and afterward, the scale for warpage measurement is moved to the fired body, where the amount of movement of the scale at the time the above mentioned scale makes contact with the fired body is read. According to doing this, the amount of warpage was carried out.

TABLE 1

| | Moisture | | | | | | Dry- | | | |
|---|---|---|---|---|---|---|---|---|---|---|
| | content | | Drying condition | | | | eliminated | Remaining | | |
| | before | | Conveyor | | | | moisture | moisture | Amount | |
| | drying | Location of | movement | Microwave | Hot air | Hot air | content | ratio | of | |
| | (% by | microwave | speed | power | temp. | speed | (% by | (% by | warpage | |
| | weight) | irradiation | (m/min) | (kW) | (° C.) | (m/s) | weight) | weight) | (mm) | Handleability |
| Ex. 1 | 13.4 | upper and | 4.5 | 5 | 50 | 30 | 6.7 | 50 | 0.7 | ++ |
| | | lower sides | | | | | | | | |
| Ex. 2 | 13.4 | upper and | 4.5 | 5 | 80 | 30 | 9.4 | 30 | 0.9 | ++ |
| | | lower sides | | | | | | | | |
| Ex. 3 | 13.4 | upper and | 4.5 | 5 | 60 | 30 | 8.0 | 40 | 0.8 | ++ |
| | | lower sides | | | | | | | | |
| Ex. 4 | 13.4 | upper and | 4.5 | 5 | 40 | 30 | 5.4 | 60 | 0.6 | + |
| | | lower sides | | | | | | | | |
| Ex. 5 | 13.4 | upper and | 2.0 | 5 | 50 | 30 | 8.0 | 40 | 0.5 | ++ |
| | | lower sides | | | | | | | | |
| Ex. 6 | 13.4 | upper and | 4.0 | 5 | 50 | 30 | 7.4 | 45 | 0.8 | ++ |
| | | lower sides | | | | | | | | |
| Ex. 7 | 13.4 | upper and | 6.0 | 5 | 50 | 30 | 6.0 | 55 | 0.6 | ++ |
| | | lower sides | | | | | | | | |
| Ex. 8 | 13.4 | upper and | 8.0 | 5 | 50 | 30 | 5.4 | 60 | 0.6 | + |
| | | lower sides | | | | | | | | |
| Ex. 9 | 13.4 | upper and | 4.5 | 5 | 50 | 20 | 5.4 | 60 | 0.6 | + |
| | | lower sides | | | | | | | | |
| Ex. 10 | 13.4 | upper and | 4.5 | 5 | 50 | 40 | 6.7 | 50 | 0.8 | ++ |
| | | lower sides | | | | | | | | |
| Ref. | 13.4 | upper and | 4.5 | 5 | 100 | 30 | 10.7 | 20 | 1.1 | ++ |
| Ex. 1 | | lower sides | | | | | | | | |
| Ref. | 13.4 | upper and | 4.5 | 5 | 50 | 50 | 6.7 | 50 | 1.1 | ++ |
| Ex. 2 | | lower sides | | | | | | | | |
| Ref. | 13.4 | upper and | 4.5 | 5 | 30 | 30 | 4.0 | 70 | 0.5 | − |
| Ex. 3 | | lower sides | | | | | | | | |
| Ref. | 13.4 | upper and | 10.0 | 5 | 50 | 30 | 4.0 | 70 | 0.5 | − |
| Ex. 4 | | lower sides | | | | | | | | |
| Ref. | 13.4 | upper and | 4.5 | 5 | 50 | 10 | 4.0 | 70 | 0.5 | − |
| Ex. 5 | | lower sides | | | | | | | | |
| Comp. | 13.4 | upper side | 4.5 | 5 | 50 | 30 | 6.0 | 55 | 1.2 | ++ |
| Ex. 1 | | | | | | | | | | |

As is shown in Table 1, in the Examples, the handleability of the honeycomb molded body was satisfactory, having either no deformation or a deformation of less than 1 mm. And the amount of warpage of the honeycomb fired body was small, i.e., 0.8 mm or less.

Alternately, in the Reference Examples 1 and 2, while the handleability of the honeycomb molded body was satisfactory, the amount of warpage of the honeycomb fired body was relatively great, i.e., at a value of 1.1 mm. This is thought to have been caused by a sharp rise in the progression of the drying of the honeycomb molded body due to an excessively high heating temperature (Reference Example 1) and the airspeed of the hot air being too fast (Reference Example 2).

And in the Reference Examples 3 to 5, while the amount of warpage of the honeycomb fired body was as small as 0.5 mm, handleability of the honeycomb molded body was inferior. This is thought to have been caused by insufficient progression of drying of the honeycomb molded body due to the temperature of the hot air being too low (Reference Example 3), the drying time being too short (Reference Example 4), and the air speed of the hot air being too slow (Reference Example 5).

And in the Comparative Example 1, although the handleability of the honeycomb molded body was satisfactory, the amount of warpage of the honeycomb fired body was great, i.e., at 1.2 mm. This is thought to have been caused by the inability of drying to progress uniformly due to the microwaves being irradiated only from the upper side with respect to the honeycomb molded body.

It should be noted that the exemplary embodiments depicted and described herein set forth the preferred embodiments of the present invention, and are not meant to limit the scope of the claims hereto in any way. Numerous modifications and variations of the present invention are possible in light of the above teachings. It is therefore to be understood that, within the scope of the appended claims, the invention may be practiced otherwise than as specifically described herein.

What is claimed as new and desired to be secured by Letters Patent of the United States is:

1. A drying apparatus comprising:
a conveying member configured to convey an item to be dried;
a plurality of microwave irradiation portions disposed alternately at an upper side and a lower side of said conveying member; and
a plurality of hot air blowing portions,
wherein said microwave irradiation portions are configured to irradiate the item to be dried with microwaves in an alternating manner from the upper side and the lower side, and
wherein said hot air blowing portions are configured to apply hot air to the item to be dried in parallel with irradiation of the microwaves by said microwave irradiation portions.

2. The drying apparatus according to claim 1, further comprising a microwave agitation blade provided at a ceiling portion of said drying apparatus.

3. The drying apparatus according to claim 2, wherein said microwave agitation blade is installed near each of said microwave irradiation portions.

4. The drying apparatus according to claim 1,
wherein said conveying member is a belt conveyor onto which a ceramic molded body is to be placed, and
wherein said belt conveyor moves intermittently, or continuously at a constant or varying speed.

5. The drying apparatus according to claim 1, further comprising a plurality of hot air aspiration portions.

6. The drying apparatus according to claim 5, wherein said hot air blowing portions and said hot air aspiration portions are disposed in an opposing manner on opposing side of said conveying member.

7. The drying apparatus according to claim 1, wherein said conveying member is configured to convey a honeycomb molded body as the item to be dried.

8. A method for drying a ceramic molded body, said method comprising:
placing a ceramic molded body on a conveying member; and
passing the ceramic molded body through an interior of a drying apparatus to dry the ceramic molded body,
wherein the ceramic molded body is passed through the interior of the drying apparatus in a prescribed period of time by using the conveying member,
wherein the drying apparatus includes:
a plurality of microwave irradiation portions disposed alternately at an upper side and a lower side of the conveying member; and
a plurality of hot air blowing portions, and
wherein, as the ceramic molded body is passed through the interior of the drying apparatus, the microwave irradiation portions irradiate the ceramic molded body with microwaves in an alternating manner from the upper side and the lower side, and the hot air blowing portions carry out a hot air drying in parallel with irradiation of the microwaves.

9. The method for drying a ceramic molded body according to claim 8, wherein a moisture content of the ceramic molded body after drying is about 30% by weight or more, and is less than about 70% by weight of the moisture content before drying.

10. The method for drying a ceramic molded body according to claim 8, wherein a temperature of hot air from the hot air blowing portions is at least about 40° C. and at most about 80° C.

11. The method for drying a ceramic molded body according to claim 8, wherein the conveying member is a belt conveyor.

12. The method for drying a ceramic molded body according to claim 8, wherein the prescribed period of time is at least about 2 minutes and at most about 3 minutes.

13. The method for drying a ceramic molded body according to claim 8, wherein airspeed of hot air from the hot air blowing portions is at least about 20 m/sec and at most about 40 m/sec.

14. The method for drying a ceramic molded body according to claim 8, wherein the ceramic molded body is a honeycomb molded body.

15. A method for manufacturing a honeycomb structure, said method comprising:
producing a pillar-shaped honeycomb molded body having a multiplicity of cells placed in parallel with one another in a longitudinal direction with a cell wall therebetween by molding a ceramic raw material;
placing the honeycomb molded body on a conveying member;
drying the honeycomb molded body by passing the honeycomb molded body through an interior of a drying apparatus, wherein the honeycomb molded body is passed through the interior of the drying apparatus in a prescribed period of time using the conveying member; and
firing the dried honeycomb molded body to manufacture a honeycomb structure comprising a honeycomb fired body,
wherein the drying apparatus includes:
a plurality of microwave irradiation portions disposed alternately at an upper side and a lower side of the conveying member; and
a plurality of hot air blowing portions, and
wherein, as the honeycomb molded body is passed through the interior of the drying apparatus, the microwave irradiation portions irradiate the honeycomb molded body with microwaves in an alternating manner from the upper side and the lower side, and the hot air blowing portions carry out a hot air drying in parallel with irradiation of the microwaves.

16. The method for manufacturing a honeycomb structure according to claim 15, wherein a moisture content of said honeycomb molded body after drying is about 30% by weight or more, and is less than about 70% by weight of the moisture content before drying.

17. The method for manufacturing a honeycomb structure according to claim 15, wherein a temperature of hot air from the hot air blowing portions is at least about 40° C. and at most about 80° C.

18. The method for manufacturing a honeycomb structure according to claim 15, wherein the conveying member is a belt conveyor.

19. The method for manufacturing a honeycomb structure according to claim 15, wherein the prescribed period of time is at least about 2 minutes and at most about 3 minutes.

20. The method for manufacturing a honeycomb structure according to claim 15, wherein airspeed of hot air from the hot air blowing portions is at least about 20 m/sec and at most about 40 m/sec.

21. The method for manufacturing a honeycomb structure according to claim 15, wherein further drying is carried out on the honeycomb molded body in a state in which the honeycomb molded body is held by a drying jig, in order to nearly completely eliminate moisture within said honeycomb molded body.

22. The method for manufacturing a honeycomb structure according to claim 21, wherein said further drying is carried out using hot air.

23. The method for manufacturing a honeycomb structure according to claim 15, wherein degreasing and firing are carried out on the honeycomb molded body in a state in which a multitude of cells are placed in parallel with one another in the longitudinal direction with a cell wall therebetween, and a plug material paste being filled in a prescribed cell.

24. The method for manufacturing a honeycomb structure according to claim 15, wherein the honeycomb structure is comprised of a plurality of honeycomb fired bodies bound together by interposing a sealing material.

25. The method for manufacturing a honeycomb structure according to claim 15, wherein the honeycomb structure is comprised of one honeycomb fired body.
